(19) United States
(12) Patent Application Publication
(10) Pub. No.: US 2026/0237051 A1
(43) Pub. Date: Aug. 13, 2026

(54) DESIGN-BASED IMAGE SEGMENTATION AND SIMULATION FOR EXAMINATION OF SEMICONDUCTOR SPECIMENS

(71) Applicant: Applied Materials Israel Ltd., Rehovot (IL)

(72) Inventors: Ran ITAY, Rishon Lezion (IL); Ran YACOBY, Jerusalem (IL); Boris LEVANT, Rehovot (IL); Noam TAL, Kiryat Ono (IL); Boaz STURLESI, Tel-Aviv (IL); Bar DUBOVSKI, Beit Hashmonay (IL); Tzipora Faigel BIALISTOTZKI, Rehovot (IL)

(21) Appl. No.: 19/050,055

(22) Filed: Feb. 10, 2025

(51) Int. Cl. G06T 7/00; G06T 7/11

(52) U.S. Cl. CPC G06T 7/0006; G06T 7/001; G06T 7/11; G06T 2207/10061; G06T 2207/20048; G06T 2207/20081; G06T 2207/20084; G06T 2207/30148

(57) ABSTRACT

There is provided a system and method of examining a semiconductor specimen using a machine learning (ML) system comprising a first ML model and a second ML model. The method includes obtaining a runtime image capturing an image pattern of interest (POI) in the specimen, and a design image containing a design POI corresponding to the image POI; using the trained first ML model to process the runtime image and the design image, to obtain a spatial transformation map indicative of spatial transformation from the design POI to the image POI; and applying the spatial transformation map on the design image to obtain a transformed design image comprising a transformed design POI matching the geometry of the image POI in the runtime image. The first ML model has been previously trained in conjunction with the second ML model.

### TECHNICAL FIELD

The presently disclosed subject matter relates, in general, to the field of examination of a semiconductor specimen, and more specifically, to machine-learning based image segmentation and simulation.

### BACKGROUND

Current demands for high density and performance associated with ultra large-scale integration of fabricated devices require submicron features, increased transistor and circuit speeds, and improved reliability. As semiconductor processes progress, pattern dimensions such as line width, and other types of critical dimensions, are continuously shrunken. Such demands require formation of device features with high precision and uniformity, which, in turn, necessitates careful monitoring of the fabrication process, including automated examination of the devices while they are still in the form of semiconductor wafers.

Examination can be provided by using non-destructive examination tools during or after manufacture of the specimen to be examined. A variety of non-destructive examination tools includes, by way of non-limiting example, scanning electron microscopes, atomic force microscopes, and optical inspection tools, etc.

Examination processes can include a plurality of examination steps. The manufacturing process of a semiconductor device can include various procedures such as etching, depositing, planarization, growth such as epitaxial growth, implantation, etc. The examination steps can be performed a multiplicity of times, for example after certain process procedures, and/or after the manufacturing of certain layers, or the like. Additionally, or alternatively, each examination step can be repeated multiple times, for example for different wafer locations, or for the same wafer locations with different examination settings.

Examination processes are used at various steps during semiconductor fabrication to detect and classify defects on specimens, as well as perform metrology related operations. Effectiveness of examination can be improved by automatization of process(es) such as, for example, defect detection, Automatic Defect Classification (ADC), Automatic Defect Review (ADR), image segmentation, automated metrology-related operations, etc.

Automated examination systems ensure that the parts manufactured meet the quality standards expected and provide useful information on adjustments that may be needed to the manufacturing tools, equipment, and/or compositions, depending on the type of defects identified. In some cases, machine learning technologies can be used to assist the automated examination process so as to promote higher yield.

### SUMMARY

In accordance with certain aspects of the presently disclosed subject matter, there is provided a computerized system for examining a semiconductor specimen, the system comprising a processing circuitry configured to obtain a runtime image capturing an image pattern of interest (POI) in the specimen, and a design image containing a design POI corresponding to the image POI; use a trained first machine learning (ML) model to process the runtime image and the design image, to obtain a spatial transformation map indicative of spatial transformation from the design POI to the image POI; and apply the spatial transformation map on the design image to obtain a transformed design image comprising a transformed design POI matching geometry of the image POI in the runtime image.

The first ML model has been previously trained as part of a ML system in conjunction with a second ML model, where the first ML model has been trained for spatial transformation from design patterns to corresponding image patterns, while the second ML model has been trained for image simulation based on output of the first ML model.

In addition to the above features, the system according to this aspect of the presently disclosed subject matter can comprise one or more of features (i) to (ix) listed below, in any desired combination or permutation which is technically possible:
(i). The processing circuitry can be further configured to use the transformed design image to obtain a metrology measurement for the runtime image.
(ii). The processing circuitry can be further configured to detect a first type of defect with respect to the image POI based on the transformed design image and the design image.
(iii). The processing circuitry can be further configured to use the trained second ML model to process the transformed design image to generate a simulated image thereof.
(iv). The processing circuitry can be further configured to detect a second type of defect on the specimen based on the simulated image and the runtime image.
(v). The processing circuitry can be further configured to implant a design defect in the transformed design image, causing the simulated image generated by the second ML model to include a simulated image defect, and include the simulated image and the runtime image as a pair of training images for training an additional ML model configured for defect detection.
(vi). The processing circuitry can be further configured to add metrology variations to the transformed design POI in the transformed design image, causing the simulated image generated by the second ML model to include a simulated image POI with added metrology variations, and include the simulated image and the runtime image as a pair of training images for training an additional ML model configured for a metrology application.
(vii). The runtime image and the design image can be coarsely aligned, without rigid registration.
(viii). The first ML model and the second ML model have been trained in conjunction using one or more loss functions comprising a first loss function configured for preserving continuity in the output of the first ML model.
(ix). The one or more loss functions further comprise a second loss function configured to reduce a difference between output of the second ML model and a corresponding actual image.

In accordance with other aspects of the presently disclosed subject matter, there is provided a computerized method of training a machine learning (ML) system comprising a first ML model and a second ML model, the method comprising: obtaining a training set comprising one or more image pairs, each image pair comprising an actual image capturing an image training pattern and a design image containing a design training pattern corresponding to the image training pattern; for each image pair in the training set, processing the image pair using the first ML model to obtain a spatial transformation map indicative of spatial transformation from the design training pattern to the image training pattern; applying the spatial transformation map on the design image to obtain a transformed design image comprising a transformed design training pattern matching geometry of the image training pattern in the actual image; processing the transformed design image using the second ML model to obtain a simulated image; and optimizing the first ML model and the second ML model together, using one or more loss functions based on the spatial transformation map, the simulated image, and the actual image.

This aspect of the disclosed subject matter can comprise one or more of features (i) to (ix) listed above with respect to the system, mutatis mutandis, in any desired combination or permutation which is technically possible. In addition to or in lieu of the above features, this aspect can comprise one or more of features (x) to (xvii) listed below, in any desired combination or permutation which is technically possible:
(x). The first ML model, upon being trained, is usable for providing a segmentation map for a runtime image based on a corresponding design image thereof.
(xi). The second ML model, upon being trained, is usable for providing a simulated image based on a design image or a transformed design image of a runtime image.
(xii). The simulated image has preserved process variation with respect to the runtime image.
(xiii). The one or more loss functions comprise a first loss function to be applied on the spatial transformation map, the first loss function configured for preserving continuity of the transformed design training pattern in the transformed design image.
(xiv). The one or more loss functions further comprise a second loss function configured to reduce a difference between the simulated image and the actual image.
(xv). The actual image and the design image in an image pair are coarsely aligned, without rigid registration.
(xvi). The actual image in each image pair of the training set is a nominal image free of defects.
(xvii). The first ML model is trained without a ground truth segmentation map.

In accordance with other aspects of the presently disclosed subject matter, there is provided a non-transitory computer-readable medium comprising instructions that, when executed by a computer, cause the computer to perform a method of examining a semiconductor specimen, the method comprising: obtaining a runtime image capturing an image pattern of interest (POI) in the specimen, and a design image containing a design POI corresponding to the image POI; using a trained first machine learning (ML) model to process the runtime image and the design image, to obtain a spatial transformation map indicative of spatial transformation from the design POI to the image POI; and applying the spatial transformation map on the design image to obtain a transformed design image comprising a transformed design POI matching geometry of the image POI in the runtime image.

This aspect of the disclosed subject matter can comprise one or more of features (i) to (xvii) listed above, mutatis mutandis, in any desired combination or permutation which is technically possible.

### BRIEF DESCRIPTION OF THE DRAWINGS

In order to understand the disclosure and to see how it may be carried out in practice, embodiments will now be described, by way of non-limiting example only, with reference to the accompanying drawings, in which:

FIG. 1 illustrates a generalized block diagram of an examination system in accordance with certain embodiments of the presently disclosed subject matter.

FIG. 2 illustrates a generalized flowchart of training an ML system usable for examining a semiconductor specimen in accordance with certain embodiments of the presently disclosed subject matter.

FIG. 3 illustrates a generalized flowchart of runtime examination of a semiconductor specimen using the trained ML system in accordance with certain embodiments of the presently disclosed subject matter.

FIG. 4 illustrates a generalized flowchart of training data enrichment for an ML model dedicated to defect detection in accordance with certain embodiments of the presently disclosed subject matter.

FIG. 5 illustrates a generalized flowchart of another training data enrichment process for an ML model dedicated to metrology, according to certain embodiments of the presently disclosed subject matter.

FIG. 6 illustrates an example of how training data can be enriched by implanting an artificial defect into the transformed design image in accordance with certain embodiments of the presently disclosed subject matter.

FIG. 7 shows a schematic illustration of the overall training process for the ML system in accordance with certain embodiments of the presently disclosed subject matter.

FIG. 8 illustrates an example of how the second ML model can generate simulated images while preserving process variation (PV), in accordance with certain embodiments of the presently disclosed subject matter.

### DETAILED DESCRIPTION OF EMBODIMENTS

The process of semiconductor manufacturing often requires multiple sequential processing steps and/or layers, some of which could possibly cause errors that may lead to yield loss. Examples of various processing steps can include lithography, etching, depositing, planarization, growth (such as, e.g., epitaxial growth), and implantation, etc. Various examination operations, such as defect-related examination (e.g., defect detection, defect review, and defect classification, etc.), and/or metrology-related examination (e.g., critical dimension (CD) measurements, and overlay, etc.), can be performed at different processing steps/layers during the manufacturing process to monitor and control the process.

In some cases, machine learning (ML) technologies can be used to assist the examination process so as to provide accurate and efficient solutions for automating specific examination applications and promoting higher yield. Most existing ML systems for wafer inspection and metrology are trained using ground truth annotations for examination applications such as segmentation, defect localization, or other tasks. Generating these annotations can require highly skilled operators and specialized equipment, leading to increased costs and potential bottlenecks. Consequently, methods that can leverage design information, without necessitating manual annotation or extensive registration efforts, present a promising direction for more efficient, scalable, and accurate semiconductor inspection and metrology.

By way of example, one of the primary challenges in many ML-driven semiconductor examination workflows lies in developing robust segmentation models for delineating various structures within SEM (Scanning Electron Microscope) images. Typically, these segmentation models require large quantities of ground truth segmentation maps to learn accurately. Such ground truth maps are often produced through manual annotation, a process that is not only highly time-consuming and labor-intensive, but also prone to human error, especially given the intricacy of semiconductor patterns. As device structures become increasingly complex, the burden of annotation escalates, effectively slowing down the deployment of segmentation-based inspection solutions.

In another example, image generation or simulation networks, which play a critical role in generating reference images or training data, face their own set of limitations. For instance, many conventional simulation systems rely on pre-registered (i.e., accurately aligned) design-to-image pairs. This requirement for precise registration can be difficult to meet in practice, particularly for large volumes of data, or for patterns that exhibit variations across different process steps. Moreover, certain existing simulation networks produce random or stochastic process variations (PV) in the simulated images, which may not faithfully reflect the true variations encountered during actual semiconductor fabrication. As a result, such simulated images lack the specificity needed for accurate defect detection or for training metrology algorithms that aim to capture subtle real-world variations.

Consequently, these challenges underscore a need for more advanced ML-based examination methodologies that can reduce the reliance on finely aligned data pairs, minimize the manual annotation burden, and more effectively handle real-world manufacturing variations. Overcoming these issues can help integrate both design data and captured images in a flexible manner, and realize more efficient data generation and accurate segmentation, thereby improving defect detection and metrology performance in semiconductor fabrication.

Accordingly, certain embodiments of the presently disclosed subject matter propose an ML-based examination system, which does not have one or more of the disadvantages described above. In certain embodiments of the present disclosure, an ML system comprising two ML models/networks is used, where a first ML model is employed to perform spatial transformation from design data to a segmentation map matching the image data, while a second ML model is employed to simulate an image based on the segmentation map (i.e., the transformed design data). By jointly training these two models, the system can deliver accurate segmentation without ground truth segmentation maps and rigid registration, generate more reliable simulated images free of random process variation artifacts, and enable the inspection and metrology tasks to be performed more efficiently, as will be detailed below.

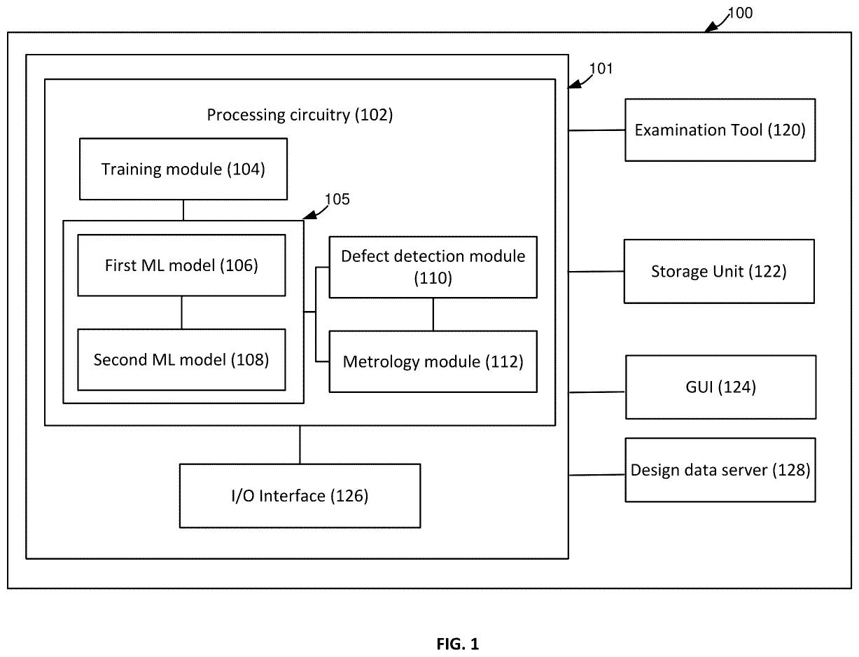

Bearing this in mind, attention is drawn to FIG. 1 illustrating a functional block diagram of an examination system in accordance with certain embodiments of the presently disclosed subject matter.

The examination system 100 illustrated in FIG. 1 can be used for examination of a semiconductor specimen (e.g., a wafer, a die, or parts thereof) as part of the specimen fabrication process. As described above, the examination referred to herein can be construed to cover any kind of operations related to defect inspection/detection, defect review, defect classification, nuisance filtration, segmentation, and/or metrology operations, etc., with respect to the specimen. System 100 comprises one or more examination tools 120 configured to scan a specimen and capture images thereof to be further processed for various examination applications.

The term “examination tool(s)” used herein should be expansively construed to cover any tools that can be used in examination-related processes, including, by way of non-limiting example, scanning (in a single or in multiple scans), imaging, sampling, reviewing, measuring, classifying, and/or other processes provided with regard to the specimen or parts thereof. Without limiting the scope of the disclosure in any way, it should also be noted that the examination tools can be implemented as inspection machines of various types, such as optical inspection machines, electron beam inspection machines (e.g., a Scanning Electron Microscope (SEM), an Atomic Force Microscopy (AFM), or a Transmission Electron Microscope (TEM), etc.), and so on.

The one or more examination tools 120 can include one or more inspection tools and/or one or more review tools. In some cases, an inspection tool can be configured to scan a specimen (e.g., an entire wafer, an entire die, or portions thereof) to capture inspection images (typically, at a relatively high speed and/or low-resolution) for detection of potential defects (i.e., defect candidates). During inspection, the wafer can move at a step size relative to the detector of the inspection tool (or the wafer and the tool can move in opposite directions relative to each other) during the exposure, and the wafer can be scanned step-by-step along swaths of the wafer by the inspection tool, where the inspection tool images a part/portion (within a swath) of the specimen at a time. By way of example, the inspection tool can be an optical inspection tool. At each step, light can be detected from a rectangular portion of the wafer, and such detected light is converted into multiple intensity values at multiple points in the portion, thereby forming an image corresponding to the part/portion of the wafer. For instance, in optical inspection, an array of parallel laser beams can scan the surface of a wafer along the swaths. The swaths are laid down in parallel rows/columns contiguous to one another, to build up, swath-at-a-time, an image of the surface of the wafer. For instance, the tool can scan a wafer along a swath from up to down, then switch to the next swath and scan it from down to up, and so on and so forth, until the entire wafer is scanned and inspection images of the wafer are collected.

In some cases, a review tool can be configured to capture review images of at least some of the defect candidates detected by inspection tools for ascertaining whether a defect candidate is indeed a defect of interest (DOI). Such a review tool is usually configured to inspect fragments of a specimen, one at a time (typically, at a relatively low speed and/or high-resolution). By way of example, the review tool can be an electron beam tool, such as, e.g., a scanning electron microscope (SEM), etc. An SEM is a type of electron microscope that produces images of a specimen by scanning the specimen with a focused beam of electrons. The electrons interact with atoms in the specimen, producing various signals that contain information on the surface topography and/or composition of the specimen. An SEM is capable of accurately inspecting and measuring features during the manufacture of semiconductor wafers.

In some embodiments of the present disclosure, at least one of the examination tools 120 has metrology capabilities and can be configured to capture images and perform metrology operations on the captured images. Such an examination tool is also referred to as a metrology tool.

One example of a metrology tool used within the examination system is a Critical Dimension Scanning Electron Microscope (CD-SEM). CD-SEM is a specialized tool designed to capture high-resolution images of semiconductor structures and perform metrology operations on those structures. The CD-SEM can be used to obtain precise dimensional measurements, such as critical dimension (CD) or overlay measurements, with respect to certain structural features on the specimen, to determine whether they meet the design specifications.

The various examination tools can be different tools located at the same or at different locations, or integrated as a single tool operated in different modes. In some cases, the same examination tool can provide low-resolution image data and high-resolution image data. The resulting image data (low-resolution image data and/or high-resolution image data) can be transmitted—directly or via one or more intermediate systems—to system 101. The present disclosure is not limited to any specific type of examination tools and/or the resolution of image data resulting from the examination tools.

According to certain embodiments of the presently disclosed subject matter, the examination system 100 comprises a computer-based system 101 operatively connected to the examination tool 120, and capable of image segmentation and simulation for ML-based examination of semiconductor specimens. System 101 is also referred to as an image segmentation and simulation system.

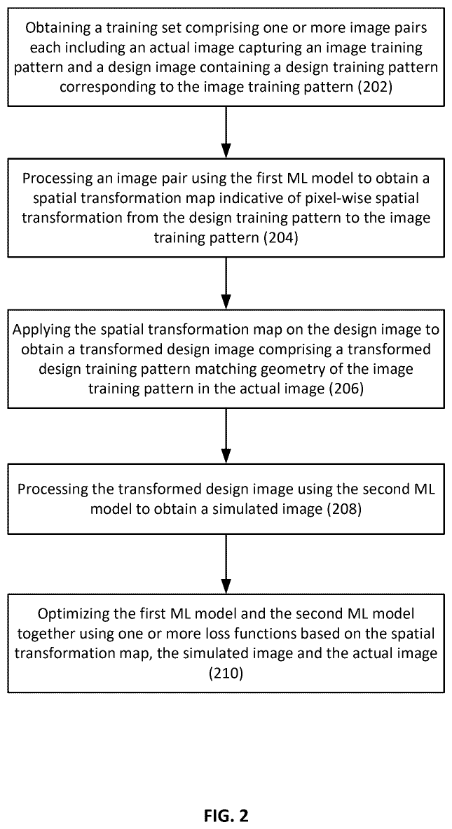

System 101 includes a processing circuitry 102 operatively connected to a hardware-based I/O interface 126 and configured to provide processing necessary for operating the system, as further detailed with reference to FIGS. 2-5. The processing circuitry 102 can comprise one or more processors (not shown separately) and one or more memories (not shown separately). The one or more processors of the processing circuitry 102 can be configured to, either separately or in any appropriate combination, execute several functional modules in accordance with computer-readable instructions implemented on a non-transitory computer-readable memory comprised in the processing circuitry. Such functional modules are referred to hereinafter as comprised in the processing circuitry.

According to certain embodiments, system 101 can be configured as a runtime examination system using a trained machine learning (ML) system. In such cases, one or more functional modules comprised in the processing circuitry 102 of system 101 can comprise a trained ML system 105 that was previously trained during a training/setup phase. The trained ML system 105 includes a trained first ML model 106 and a trained second ML model 108. In some cases, the processing circuitry 102 can further comprise various application modules operatively connected to the ML system 105, such as a defect detection module 110 and a metrology module 112.

Specifically, the processing circuitry 102 can be configured to obtain, via an I/O interface 126, a runtime image capturing an image pattern of interest (POI) in the specimen, and a design image containing a design POI corresponding to the image POI. The trained first ML model 106 can be used to process the runtime image and the design image, to obtain a spatial transformation map indicative of spatial transformation from the design POI to the image POI. The spatial transformation map can be applied onto the design image to obtain a transformed design image comprising a transformed design POI matching geometry of the image POI in the runtime image. The trained second ML model 108 can be used to process the transformed design image to obtain a simulated image thereof.

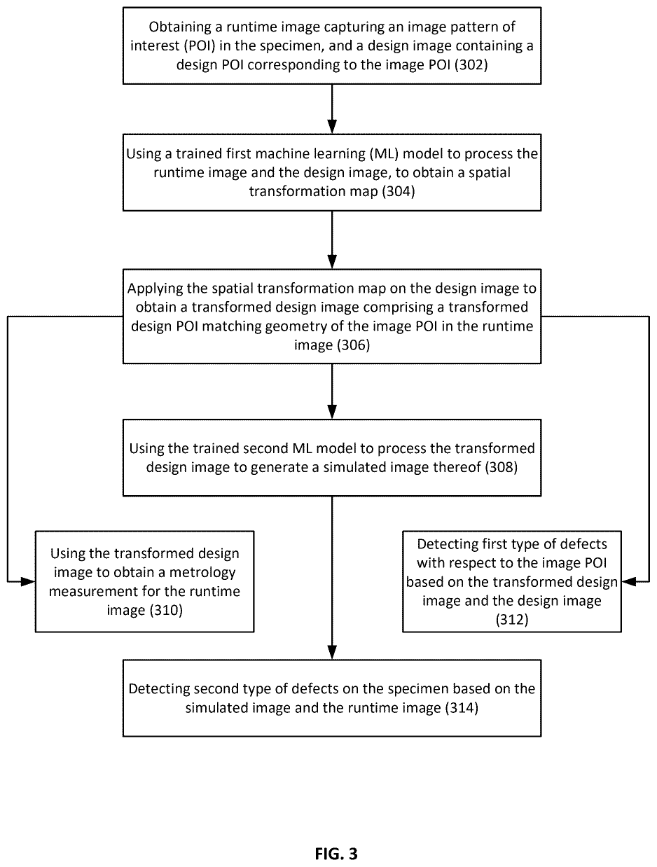

The outputs of the ML models 106 and 108 can be used for various examination applications for examining a specimen. By way of example, the application modules 110 and 112 can use these outputs, as well as at least part of the inputs, for defect detection and/or metrology purposes, as will be detailed below with reference to FIGS. 3-5.

In some cases, the trained ML system 105 and the application modules 110 and 112 can be regarded as part of an examination recipe usable for performing runtime examination operations for semiconductor specimens, including defect detection/review, metrology operations, etc., on various runtime images acquired for a specimen to be examined.

In some embodiments, system 101 can be configured as a training system capable of training the ML system 105 during a training/setup phase. In such cases, one or more functional modules comprised in the processing circuitry 102 of system 101 can include a training module 104, and an ML system 105 including the first and second ML models to be trained (i.e., the initially constructed models that are not yet trained). Specifically, the training module 104 can be configured to obtain a specific training set, and use the training set to train first and second ML models in conjunction, as will be detailed below with respect to FIG. 2.

According to certain embodiments, the ML models 106 and 108 can be implemented as various types of ML models, such as, e.g., decision tree, Support Vector Machine (SVM), Artificial Neural Network (ANN), regression model, transformer, Bayesian network, or ensembles/combinations thereof etc. The learning algorithms used by the ML models can be any of the following: supervised learning, unsupervised learning, self-supervised, semi-supervised learning, or a combination thereof, etc. The presently disclosed subject matter is not limited to the specific types of ML models or the specific types of learning algorithms used by the ML models.

By way of example, in some cases, the ML model can be implemented as a deep neural network (DNN). DNN can comprise multiple layers organized in accordance with respective DNN architecture. By way of non-limiting example, the layers of DNN can be organized in accordance with architecture of a Convolutional Neural Network (CNN), Recurrent Neural Network, Recursive Neural Networks, autoencoder, Generative Adversarial Network (GAN), or otherwise. Optionally, at least some of the layers can be organized into a plurality of DNN sub-networks. Each layer of DNN can include multiple basic computational elements (CEs), typically referred to in the art as dimensions, neurons, or nodes.

The weighting and/or threshold values associated with the CEs of a DNN and the connections thereof can be initially selected prior to training, and can be further iteratively adjusted or modified during training to achieve an optimal set of weighting and/or threshold values in a trained DNN. After each iteration, a difference can be determined between the actual output produced by DNN module and the target output associated with the respective training set of data. The difference can be referred to as an error value. Training can be determined to be complete when a loss/cost function indicative of the error value is less than a predetermined value, or when a limited change in performance between iterations is achieved. A set of input data used to adjust the weights/thresholds of a DNN is referred to as a training set.

It is noted that the teachings of the presently disclosed subject matter are not bound by the specific architecture of the ML models as described above.

It is to be noted that while certain embodiments of the present disclosure refer to the processing circuitry 102 being configured to perform the above-recited operations, the functionalities/operations of the aforementioned functional modules can be performed by the one or more processors in processing circuitry 102 in various ways. By way of example, the operations of each functional module can be performed by a specific processor, or by a combination of processors. The operations of the various functional modules, such as the first ML model processing, the second ML model processing, and various application operations, etc., can thus be performed by respective processors (or processor combinations) in the processing circuitry 102, while, optionally, these operations may be performed by the same processor. The present disclosure should not be limited to being construed as one single processor always performing all the operations.

In some cases, additionally to system 101, the examination system 100 can comprise one or more additional examination modules, such as, e.g., nuisance filtration module, Automatic Defect Review (ADR) module, Automatic Defect Classification (ADC) module, additional metrology operation module, and/or other examination modules which are usable for examination of a semiconductor specimen. The one or more examination modules can be implemented as stand-alone computers, or their functionalities (or at least part thereof) can be integrated with the examination tools 120. In some cases, the output of system 101, e.g., the segmentation map, and/or the simulated image, can be provided to the one or more additional examination modules for further processing.

According to certain embodiments, system 100 can comprise a storage unit 122. The storage unit 122 can be configured to store any data necessary for operating system 101, e.g., data related to input and output of system 101, as well as intermediate processing results generated by system 101. By way of example, the storage unit 122 can be configured to store the runtime images and/or derivatives thereof produced by the examination tool 120, and/or the training set as described above. System 100 can also comprise a design data server 128 configured to store design data and design images derived therefrom. Accordingly, the input data as required can be retrieved from the storage unit 122 and design data server 128, and provided to the processing circuitry 102 for further processing. The output of system 101, such as, e.g., the segmentation map, and/or the simulated image, can be sent to storage unit 122 to be stored.

In some embodiments, system 100 can optionally comprise a computer-based Graphical User Interface (GUI) 124 which is configured to enable user-specified inputs related to system 101. For instance, the user can be presented with a visual representation of the specimen (for example, by a display forming part of GUI 124), including the images of the defect candidates, etc. The user may be provided, through the GUI, with options of defining certain operation parameters. The user may also view the operation results or intermediate processing results, such as, e.g., the segmentation map, and/or the simulated image, etc., on the GUI.

In some cases, system 101 can be further configured to send, via I/O interface 126, the operation results to the examination tools 120 for further processing. In some cases, system 101 can be further configured to send the results to external systems (e.g., Yield Management System (YMS) of a fabrication plant (fab)). A yield management system (YMS) in the context of semiconductor manufacturing is a data management, analysis, and tool system that collects data from the fab, especially during manufacturing ramp-ups, and helps engineers find ways to improve yield. A YMS helps semiconductor manufacturers and fabs manage high volumes of production analysis with fewer engineers. These systems analyze the yield data and generate reports. A YMS can be used by Integrated Device Manufacturers (IMD), fabs, fabless semiconductor companies, and Outsourced Semiconductor Assembly and Test (OSAT).

Those versed in the art will readily appreciate that the teachings of the presently disclosed subject matter are not bound by the system illustrated in FIG. 1. Each system component and module in FIG. 1 can be made up of any combination of software, hardware, and/or firmware, as relevant, executed on a suitable device or devices, which perform the functions as defined and explained herein. Equivalent and/or modified functionality, as described with respect to each system component and module, can be consolidated or divided in another manner. Thus, in some embodiments of the presently disclosed subject matter, the system may include fewer, more, modified and/or different components, modules, and functions than those shown in FIG. 1.

Each component in FIG. 1 may represent a plurality of the particular components, which are adapted to independently and/or cooperatively operate to process various data and electrical inputs, and for enabling operations related to a computerized examination system. In some cases, multiple instances of a component may be utilized for reasons of performance, redundancy, and/or availability. Similarly, in some cases, multiple instances of a component may be utilized for reasons of functionality or application. For example, different portions of the particular functionality may be placed in different instances of the component.

It should be noted that the examination system illustrated in FIG. 1 can be implemented in a distributed computing environment, in which one or more of the aforementioned components and functional modules shown in FIG. 1 can be distributed over several local and/or remote devices. By way of example, the examination tools 120 and the system 101 can be located at the same entity (in some cases hosted by the same device) or distributed over different entities. By way of another example, as described above, in some cases, system 101 can be configured as a training system for training the ML system, while in some other cases, system 101 can be configured as a runtime examination system using the trained ML system. The training system and the runtime system can be located at the same entity (in some cases hosted by the same device), or distributed over different entities, depending on specific system configurations and implementation needs.

In some examples, certain components utilize a cloud implementation, e.g., are implemented in a private or public cloud. Communication between the various components of the examination system, in cases where they are not located entirely in one location or in one physical entity, can be realized by any signaling system or communication components, modules, protocols, software languages, and drive signals, and can be wired and/or wireless, as appropriate.

It should be further noted that in some embodiments at least some of the examination tools 120, storage unit 122, design data server 128 and/or GUI 124 can be external to the examination system 100 and operate in data communication with systems 100 and 101 via I/O interface 126. System 101 can be implemented as stand-alone computer(s) to be used in conjunction with the examination tools, and/or with the additional examination modules as described above. Alternatively, the respective functions of the system 101 can, at least partly, be integrated with one or more examination tools 120, thereby facilitating and enhancing the functionalities of the examination tools in examination-related processes.

While not necessarily so, the process of operations of systems 101 and 100 can correspond to some or all of the stages of the methods described with respect to FIGS. 2-5. Likewise, the methods described with respect to FIGS. 2-5 and their possible implementations can be implemented by systems 101 and 100. It is therefore noted that embodiments discussed in relation to the methods described with respect to FIGS. 2-4 can also be implemented, mutatis mutandis as various embodiments of the systems 101 and 100, and vice versa.

As described above, a semiconductor specimen is typically made of multiple layers. The examination process of a specimen can be performed a multiplicity of times during the fabrication process of the specimen, for example following certain processing steps of specific layers. For the purpose of illustration only, certain embodiments of the following description are described with respect to an ML system usable for examining a given processing step/layer of the specimen. Those skilled in the art will readily appreciate that the teachings of the presently disclosed subject matter can be performed for any layer and/or processing steps of the specimen. The present disclosure should not be limited to the number of processing steps/layers comprised in the specimen and/or the specific layer(s) to be examined.

Referring to FIG. 2, there is illustrated a generalized flowchart of training an ML system usable for examining a semiconductor specimen in accordance with certain embodiments of the presently disclosed subject matter.

A training set can be obtained (202) (e.g., by the training module 104 when system 101 is configured as a training system). The training set comprises one or more image pairs. Each image pair includes an actual image capturing an image training pattern and a design image containing a design training pattern corresponding to the image training pattern.

As used herein, the term “actual image” refers to a real image acquired by an examination tool, such as a scanning electron microscope (SEM), optical microscope, or others, from a physical training specimen or wafer. This actual image captures an image training pattern, which refers to a structure or feature of the training specimen that the system intends to use for training purposes.

The design image can be typically derived from electronic design data (e.g., computer-aided design (CAD) layouts, mask/reticle data, or similar sources), which represents the intended layout of features to be fabricated on the wafer. In other words, the design training pattern in the design image corresponds to the same semiconductor structures or features in the image training pattern captured by the actual image. In some cases, the design data can be broken into different layers or sub-regions, where one of these layers or sub-regions corresponds to the portion of the wafer captured in the actual image.

By way of example, the relevant portion of the design data, often a vector-based or polygon-based layout, can be extracted for the specific wafer region that corresponds to the actual image. This may involve selecting the correct layer(s) or sub-region(s) of the layout and converting those vector shapes or polygons into a rasterized format. The result is a design image that visually depicts the same pattern intended to be formed on the wafer, often without the process-related variations that might appear in the actual image.

In some cases, the design image and the actual image in an image pair can undergo a coarse alignment/registration prior to being fed into the first ML model, although a precise or rigid registration is not strictly required. For example, the system could match the approximate field of view by comparing high-level features of the images, such as major design blocks, bounding boxes of critical structures, or prominent fiducial marks, using simple image processing or geometric operations. This coarse alignment can be carried out via basic transformations performed by certain computer vision techniques, such as template matching or feature-based matching (e.g., SIFT, ORB). By ensuring that the design image is at least in the same general vicinity or scale as the actual image, the downstream learning components (e.g., the first ML model) are spared the burden of large, global misalignments, and can focus on learning finer, localized transformations. By performing coarse registration, it can both speed up the convergence of the ML system and enhance the accuracy of the final spatial transformation map.

As described above, the ML system used herein comprises a first ML model and a second ML model. The first ML model can be specifically constructed for spatial transformation from a design pattern to a corresponding image pattern. This arrangement allows the system to account for finer misalignments and/or distortions that arise when comparing ideal design data (e.g., CAD layouts) to actual images (e.g., SEM images) captured from wafers.

In certain embodiments, the first ML model may be implemented as a Spatial Transformer Network (STN). An STN generally includes a learnable transformation module (often referred to as a localization network) and a sampler that applies the transformation to the input, enabling the model to manipulate the spatial arrangement of data within a neural network. In the context of the present disclosure, the STN automatically learns the requisite geometric transformations needed to map design images onto corresponding actual images, thereby eliminating or reducing the need for manual or rigid registration.

Each image pair in the training set can be fed and processed (204) by the first ML model (e.g., an STN) to obtain a spatial transformation map indicative of spatial transformation (e.g., pixel-wise) from the design training pattern to the image training pattern. By way of example, the first ML model receives as input both the design image and the corresponding actual image, and, through the forward pass, it generates the spatial transformation map. This transformation map captures how each pixel (or sub-pixel, or group of pixels) of the design image should be transformed (e.g., shifted, scaled, or otherwise warped) to align with the real structures observed in the actual image.

In certain embodiments, the spatial transformation map can be implemented as a Deformation Vector Field (DVF), wherein each pixel (or sub-pixel, or group of pixels) in the design image is associated with a displacement vector. The displacement vector indicates to which extent and in which direction the pixel should be shifted to align with the corresponding pixel in the actual image.

Once generated, the spatial transformation map (e.g., the DVF) can be applied (206) (e.g., by the sampler of the STN) to the design image, producing a transformed design image whose design training pattern is warped to match the geometry of the image training pattern in the actual image. Conceptually, this transformed design image can be viewed as a segmentation map of the actual image because each pixel's location in the transformed design image directly correlates to a corresponding location in the actual image.

It is to be noted that the term “matching” used herein is intended to mean “substantially matching” or “closely corresponding to” in a practical sense in the context of comparing or aligning images or patterns (e.g., “matching geometry”). That is, such matching contemplates small acceptable deviations or inaccuracies that may arise from real-world manufacturing or measurement conditions, and does not require a perfect or exact correspondence in every instance. Furthermore, the term “geometry” should be interpreted broadly to include, without limitation, contour, shape, orientation, scale, and local deformations or warping, as well as any other dimensional or positional characteristics relevant to semiconductor pattern alignment.

The transformed design image can be processed (208) using the second ML model to obtain a simulated image. The second ML model is specifically constructed for image simulation/generation based on design data. The second ML model can be implemented in various network architectures. For example, the second ML model can be implemented as a generative network, such as a Generative Adversarial Network (GAN), a conditional GAN, or a similar architecture capable of taking an input image in the design domain (e.g., the transformed design image) and producing an output image in the real/SEM-like domain. In doing so, the second ML model effectively learns to mimic the appearance of semiconductor images captured by an actual imaging modality (e.g., SEM). By operating on the transformed design image that aligns with the real specimen geometry (as handled by the first ML model), the second ML model can generate simulated images that closely match the real-world process variations present in actual wafer images.

The first ML model and the second ML model can be optimized (210) (e.g., by the training module 104) together using one or more loss functions based on (i) the spatial transformation map generated by the first ML model, (ii) the simulated image generated by the second ML model, and (iii) the actual image from the training set.

This joint optimization can ensure that updates to the first ML model are informed not only by how well it aligns the design image to the actual image, but also by how well the second ML model can produce high-fidelity simulated images from the transformed design image. Conversely, the second ML model relies on the output of the first ML model, so any improvement in the first ML model's spatial alignment can enhance the quality and realism of the simulated images.

During backpropagation, the parameters of the two models are adjusted together to reduce the combined loss (via one or more loss functions). As a result, the two models learn complementary roles: the first ML model captures physical or process-related deformations (e.g., line width variation, overlay shifts) and adjusts misalignment (if any), while the second ML model focuses on translating the shape-aligned design data into a realistic image domain.

In some embodiments, the one or more loss functions comprise at least two main components. A first loss function can be configured for preserving continuity in the transformed design training pattern in the transformed design image. The first loss, i.e., a “continuity-preserving” loss function (also referred to as smoothness loss), can be applied to the spatial transformation map to discourage sudden or unrealistic warping discontinuities. For instance, the smoothness loss can be computed by taking the gradient of the DVF and penalizing large local gradients, thereby ensuring that the transformation from design image to actual image is continuous. By way of example, such a loss may be expressed as follows:

$${L}_{smoothness} = {\sum }_{( x , y )} {‖ ∇ DVF ( x , y ) ‖}^{2}$$

where ∇DVF(x,y) denotes the spatial gradient of the deformation vectors at pixel (x,y). This term ensures that the warping aligns realistically with physical deformations found in wafer processing, rather than creating abrupt transitions.

By minimizing this term, the first ML model can be encouraged to produce a smoothly varying DVF (i.e., a continuous transformation of the design image), preventing discontinuities or abrupt warping artifacts. This continuity-preserving mechanism reflects the practical understanding that process variations in a wafer typically shift or deform patterns in a smooth, localized manner, rather than creating sudden jumps or discontinuities. The application of such a smoothness loss function allows the first ML model to learn realistic deformations that accurately map the design image onto the actual image, while maintaining spatial continuity.

In addition to the first loss, a second loss function which is difference-based can be employed between the simulated image and the actual image. By way of example, this difference-based loss can be based on a distance metric, e.g., taking the form of an L1 or L2 distance, or a more sophisticated adversarial loss if the second ML model is a GAN. The key objective is to reduce the discrepancy between the simulated image and the actual wafer image, thus driving the second ML model to produce even more realistic simulations.

The above training process can be performed end-to-end, with the gradients from the two loss functions, including the gradients from the final comparison (e.g., between simulated images and actual images) and the gradients from the DVF, propagating back through both the second ML model and the first ML model. This mechanism adjusts the first ML model's spatial transformations to optimize the continuity of the transformed design image, while fine-tuning the second ML model for high fidelity and realism of the final simulated images.

One of the technical advantages is that the first ML model can be trained without ever needing a ground truth segmentation map. This is enabled by the joint (end-to-end) training scheme: the correctness of the transformed design image can be indirectly enforced through the second ML model's simulation loss (i.e., the difference between the simulated image and the actual image), such that the learned transformation inherently acts as a segmentation map without requiring explicit segmentation labels.

Another technical advantage is that no rigid registration is strictly required for the design and actual images. Instead, the first ML model's learned local transformations, possibly aided by an optional coarse alignment, capture the necessary shifts and deformations between the design domain and the actual wafer images, obviating the need for precise, rigid registration in most cases.

It is to be noted that the term “coarse alignment” (or “coarse registration”) is intended to encompass an approximate alignment of the design image and the actual image in position, orientation, and/or scale. Such coarse alignment aims at bringing the images into a similar field of view. By contrast, the term “rigid registration” refers to an alignment process related to rigid transformations such as translations, and/or rotations, typically without accommodating non-rigid operations such as localized deformations, or other forms of warping. Consequently, “coarse alignment” in some cases may, but need not, involve “rigid registration” and typically serves merely as a preliminary step before more precise transformations (e.g., learned local transformations) are applied.

In some embodiments, the first ML model, upon being fully trained, is usable for providing a segmentation map for a runtime image based on its corresponding design image. For instance, once trained, the first ML model can generate (or predict) a spatial transformation map (e.g., the Deformation Vector Field, DVF) for any given design image associated with a new runtime image, effectively transforming it to match the geometry in the runtime image. The resulting transformed design image can serve as an accurate segmentation map of the runtime image, indicating which parts of the runtime image correspond to different design structures or features.

In some embodiments, the second ML model, upon being trained, is usable for providing a simulated image from design data of a runtime image. In particular, the simulated image is provided with preserved process variation (PV) with respect to the runtime image. This preservation arises because the first ML model handles localized deformations that reflect real-world PV, effectively shaping the design data to match actual wafer contours. By the time the second ML model receives the transformed design image, the underlying geometry already encodes the same PV patterns seen in the real wafer. Consequently, the second ML model can focus on “domain translation”—e.g., accurately replicating texture, contrast, and other imaging attributes. This division of functionality between the two ML models ensures that the simulated images closely mimic the actual appearance of the wafer, rather than introducing arbitrary or random process variations.

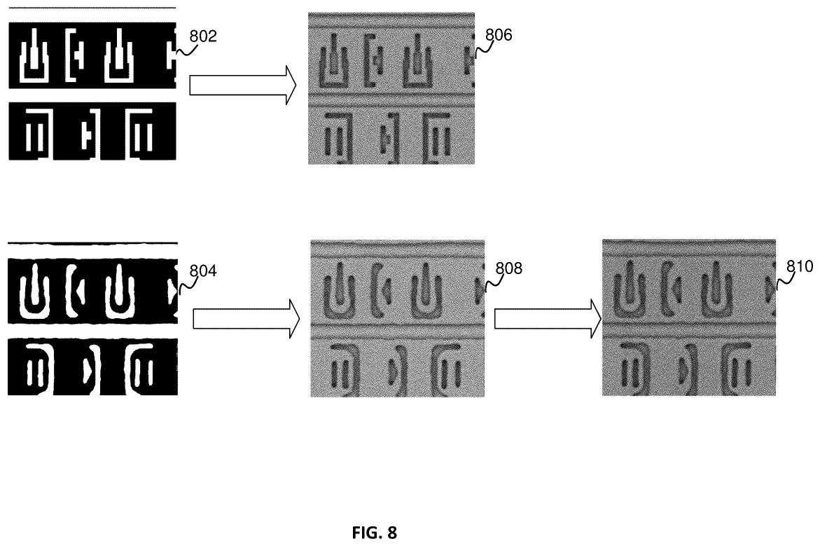

FIG. 8 illustrates an example of how the second ML model (also referred to as the “simulation network” in some embodiments) can generate simulated images while preserving process variation (PV), in accordance with certain embodiments of the present disclosure. Unlike conventional simulation techniques that may randomly hallucinate geometric deformations, the second ML model described here operates as part of the ML system, separating the roles of domain translation and shape alignment, thereby ensuring that any PV observed in the actual wafer images is accurately retained, rather than synthesized arbitrarily.

In the illustrated example, image 802 represents an original design image. Typically, a design image such as 802 can be derived from CAD or mask data in a binary or polygon-based format, showing the intended layout of features without any real-world process effects. Image 804 represents the corresponding “transformed” design image of 802, where the first ML model has already applied a learned spatial transformation map (e.g., a deformation vector field) to align the design data with the real geometry observed in a corresponding runtime image 810. Both 802 and 804 are shown as binary images, but image 804 displays shapes and edges that have been deformed to correlate or match the actual contours present in the runtime image 810. By performing this spatial transformation, the first ML model effectively captures the PV inherent in the specimen, encoding it into the geometry of the transformed design image.

As described above, the second ML model (the simulation network) is trained to perform a domain translation task while leaving geometric alignment to the first ML model. Consequently, once the design image has been transformed (as shown in 804), feeding 804 into the second ML model yields a simulated image that reflects the real-world PV of the corresponding runtime image. In other words, because the shape alignment already encodes the local deformations or variations, the second ML model no longer needs to guess or randomly introduce such deformations. Instead, it focuses on rendering realistic image characteristics, such as contrast, noise, and texture, commonly observed in an actual imaging modality (e.g., SEM). As a result, the second ML model “stops hallucinating” stochastic process variations, and instead produces a simulated image 808 with a PV that is similar to that of the runtime image 810. This approach contrasts with many earlier simulation networks, which might inject random geometric distortions to simulate “variations”, often leading to inaccuracies or mismatches.

Moreover, if the trained second ML model processes the original (untransformed) design image 802—that is, if it is given design data that has not been spatially deformed to match the real wafer geometry—then the simulated image 806 visually corresponds to the same basic shapes and outlines present in 802, but presented in a realistic, domain-translated (e.g., SEM-like) form. In other words, the second ML model simply performs a domain translation of 802, without adding any geometry changes. Thus, the simulated image 806 retains the same general layout and structure as 802, absent any real-world variation.

This capability allows the user to selectively generate either (i) a PV-accurate simulated image (by providing the transformed design image 804), or (ii) a nominally perfect simulated image (by providing the original design image 802). As such, the disclosed system gives users the flexibility to create high-fidelity simulated images for defect detection, metrology, or other inspection tasks, with or without the incorporation of real-world process variations, based on which image is fed into the second ML model.

It is to be noted that although certain embodiments of the present disclosure describe the first ML model using a Spatial Transformer Network (STN) as an example, this is by no means intended to limit the scope of the presently disclosed subject matter. In particular, STN can be realized by various neural network architectures. For instance, an encoder-decoder network (e.g., a U-Net variant), attention-based, or transformer-based architectures, could be adapted to generate a deformation vector field (DVF). Therefore, any network solution capable of learning spatial transformations that adapt the design layout to match real-world image variations should be regarded to be within the scope of this disclosure.

Similarly, although the second ML model has been frequently illustrated herein as a generative network (e.g., a GAN, conditional GAN, or CycleGAN), this too is merely an example implementation. Other image-to-image translation or simulation architectures may be used, including variational autoencoders (VAE), diffusion-based generative models, or specialized CNN-based image synthesis networks. The specific network structure for the second ML model may vary based on design constraints, training data characteristics, or computational considerations, without departing from the scope of the present disclosure.

Moreover, while certain embodiments of the above description focus on two primary loss functions—a continuity-preserving (smoothness) loss applied to the spatial transformation map and a difference-based loss for comparing the simulated image to the actual image, this is by no means intended to limit the disclosure. Additional or alternative loss functions can be employed, either in conjunction with or in place of these examples. For instance, adversarial losses, perceptual losses, or regularization terms tailored to specific applications (e.g., shape preservation, style transfer, or noise reduction) may be incorporated to further refine the performance of the first and second ML models. Such extensions or variations remain within the scope of the present disclosure.

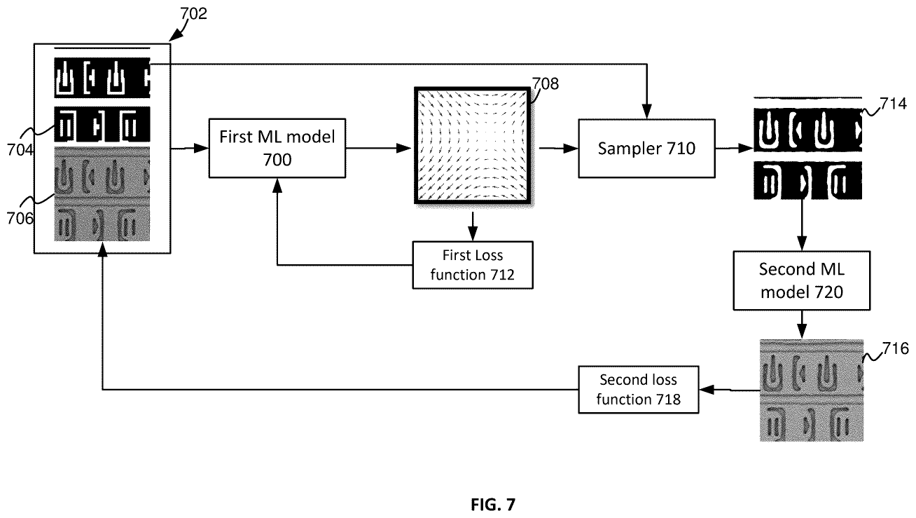

For exemplary purposes, FIG. 7 shows a schematic illustration of the overall training process for the machine learning (ML) system in accordance with certain embodiments of the presently disclosed subject matter. This figure highlights the interplay between a first ML model (used for spatial transformation) and a second ML model (used for image simulation), as well as the respective loss functions that jointly optimize both models.

In the illustrated embodiment, a training image pair 702 is provided, comprising a design image 704 and an actual/real image 706. The design image 704 typically represents the idealized layout of semiconductor patterns (e.g., derived from CAD or mask data), while the actual image 706 captures the same or corresponding wafer region through a real imaging modality (e.g., an SEM). Due to process variations, the actual image 706 may differ in geometry or local dimensions from the ideal shapes depicted in the design image 704.

This training image pair 702 is fed into the first ML model 700. The first ML model is configured to learn how to map pixels (or sub-pixels, or groups of pixels) in the design image 704 to their corresponding counterparts in the actual image 706. In doing so, the first ML model outputs a spatial transformation map 708. In this example, the transformation map 708 takes the form of a Deformation Vector Field (DVF), wherein each pixel has an associated displacement vector indicating how and where the corresponding pixel in the design image 704 should be moved in order to best match the geometry in the actual image 706.

A sampler 710 then applies this spatial transformation map 708 to the original design image 704, thus generating a transformed design image 714. The transformed design image 714 (which may be considered a warped version of the original design image 704) is now closely aligned/matched with the actual image 706, reflecting local and global deformations that account for real-world process variations. Notably, because the first ML model learns (pixel-wise) spatial transformations, it can accommodate a range of shape deviations, rather than performing a mere rigid or global alignment.

Once the design image has been transformed, the transformed design image 714 is fed into the second ML model 720. The second ML model is trained to perform image simulation or “domain translation” from design-space representations to realistic wafer images. In other words, upon receiving 714, the second ML model generates a simulated image 716 that mimics the appearance of the actual image 706. This may include reproducing lighting, contrast, texture, noise, or other imaging characteristics that are typically observed in real SEM (or other modality) images.

To jointly optimize both the first and second ML models, multiple loss functions can be employed. In the illustrated example, a first loss function 712 (often referred to as a smoothness or continuity loss) is applied directly to the spatial transformation map 708. The goal of this loss function is to discourage abrupt or non-physical discontinuities in the deformation vectors, thereby preserving the continuity and integrity of the transformed design pattern in 714. This is especially useful in semiconductor inspection contexts, where local distortions tend to be gradual rather than jumping suddenly between neighboring pixels.

Additionally, a second loss function 718 measures the difference between the simulated image 716 and the actual image 706, encouraging the second ML model to accurately mimic real-world imaging. For instance, the second loss function may take the form of a mean absolute error (L1), mean squared error (L2), perceptual loss, adversarial loss (if using a GAN setup), or any suitable measure of similarity. By minimizing this difference, the second ML model learns to synthesize highly realistic wafer images from the transformed design data.

Both of these loss functions can be optimized simultaneously (along with possible additional losses), enabling end-to-end training of the two-model system. Gradients from the second model's simulation loss flow backward to adjust parameters of both the second ML model and the first ML model, ensuring that the first ML model's learned transformations also contribute to generating faithful simulated images. Conversely, the smoothness loss on the DVF refines the first model's ability to warp design images in a continuous, physically plausible manner. By iterating through these training steps, the ML system can converge on a solution that both correctly aligns design data with real wafer images and realistically simulates the appearance of those images once aligned.

Having described the training process of the ML system, reference is made to FIG. 3 illustrating a generalized flowchart of runtime examination of a semiconductor specimen using the trained ML system in accordance with certain embodiments of the presently disclosed subject matter. This runtime (or inference) process leverages the model parameters learned during training, allowing the ML system to perform various examination operations, such as defect detection, metrology, or other examination tasks on newly acquired wafer images without extensive manual intervention.

Specifically, a runtime image capturing an image pattern of interest (POI) in a semiconductor specimen, and a design image containing a design POI corresponding to the image POI, can be obtained (302) (e.g., by the processing circuitry 102 from the examination tool 120).

The runtime image refers to an image that is actually acquired by an examination tool as described above, or any derivatives of the actually acquired image (such as resulting from any pre-processing of the acquired image). The runtime image may be acquired using various imaging modalities. For instance, a runtime image can be an optical image acquired by an optical inspection tool, or an electron beam (e-beam) image acquired by an electron beam tool during in-line examination of the specimen. A semiconductor specimen used herein can refer to a semiconductor wafer, a die, or parts thereof, that is fabricated and examined in the fab during a fabrication process thereof. A runtime image refers to an image capturing at least part of the specimen. By way of example, an image can capture a region containing a structure or pattern that is of interest to be examined on the specimen.

The design image corresponding to the runtime can be typically derived from electronic design data (such as CAD layouts, mask or reticle data), e.g., the portion of design data that contains a design POI corresponding to the image POI. Optionally, a coarse alignment procedure may be performed to ensure these images occupy roughly the same field of view. However, as described above, a precise or rigid registration is not strictly required due to the learned transformation capabilities.

A trained first machine learning (ML) model can be used (304) to process the runtime image and the design image, to obtain a spatial transformation map. As described above, this first ML model—previously trained in conjunction with a second ML model, as described above with reference to FIG. 2—now functions as a learned transformation engine. For example, if the first ML model comprises a Spatial Transformer Network (STN), it receives both the design image and the runtime image as inputs, and outputs a deformation vector field (DVF) or another form of spatial transformation map. This transformation map indicates how the design image should be transformed/warped so its geometry substantially matches that of the runtime image's POI.

The spatial transformation map can be applied (306) on the design image to obtain a transformed design image comprising a transformed design POI matching (or “substantially matching”) the geometry of the image POI in the runtime image. In this step, each pixel (or sub-pixel, or group of pixels) in the design image can be shifted, rotated, scaled, or otherwise warped in accordance with the computed deformation vectors. The resulting transformed design image may be regarded as a segmentation map of the runtime image, because each location in the transformed design image corresponds directly to a corresponding structure or feature in the runtime image. Notably, as the first ML model can capture local deformations between the design and image patterns, even subtle process variations are accounted for, leading to more accurate segmentation results.

In some embodiments, the trained second ML model can be used (308) to process the transformed design image to generate a simulated image thereof. As described above with respect to the training phase, the second ML model is optimized for image simulation or “domain translation,” converting the shape-aligned design domain into a realistic image domain (e.g., SEM-like appearance). Because the first ML model aligns the design data to the actual wafer geometry, the second ML model can focus on replicating imaging characteristics, such as contrast, noise, or fine texture, consistent with actual wafer images.

It is to be noted that this step can be optional—in some runtime scenarios, only the transformed design image is needed (e.g., for metrology use cases, as will be described below), while in other scenarios, the simulated image enables further examination abilities, such as in the use cases of defect detection or data enrichment tasks, as will be described in further detail below.

Multiple applications and use cases can leverage the outputs of the ML models. For instance, the transformed design image which serves as an accurate, automatically generated segmentation map, and/or the simulated image which captures realistic imaging characteristics, can be used to streamline inspection, facilitate metrology, detect defects, and/or generate synthetic training data for other machine learning tasks.

By way of example, one possible use case is using (310) the transformed design image (i.e., a segmentation map of the runtime image) to obtain a metrology measurement for the runtime image. In this use case, the system can measure various metrology measurements, such as critical dimensions (CD), overlay, line-edge roughness, or other metrology parameters directly from the transformed design image, which is geometrically aligned/matched to the runtime image. This alignment-based metrology can significantly reduce runtime computation efforts for image segmentation and/or contour/edge extraction for the runtime image. In addition, as the training process teaches the first ML, model how to adapt the design data to actual wafer conditions, the metrology measurements obtained in this manner reflect real-world process variations of the runtime image while maintaining the structural intent of the design.

The metrology measurement obtained in this manner is observed to have improved performance with respect to various metrology metrics such as, e.g., precision (indicative of repeatability of independent measurements of the same feature/pattern). In addition, empirical results may demonstrate close correlation of the obtained metrology measurements with respect to actual physical measurements, making this approach particularly suitable for advanced process nodes or complex multi-layer wafer designs, where traditional metrology approaches encounter alignment or segmentation challenges.

Another possible use case is to detect (312) a first type of defects with respect to the image POI, e.g., pattern-related defects, based on the transformed design image and the original design image. Because both the original and the transformed design images are effectively “binary” or shape-based representations of the intended layout, differences between the two can highlight regions that deviate from the original design intent. For example, if a portion of the pattern is missing, shifted, or inadvertently formed, such differences become evident by comparing the original design data (representing the intended shapes) and the transformed design data (representing the shapes as actually aligned to the runtime image). As a result, pattern-related defects (e.g., open circuits, shorts, missing features) can be quickly identified.

Additionally or alternatively, a second type of defect can be detected (314) on the specimen, based on the simulated image and the runtime image. The second type of defects refers to local, finer defects that manifest as gray-level variations, for instance micro-bridges, line edge roughness, or subtle process-induced distortions. Because the simulated image is designed to mimic the runtime image with preserved process variations (including the shape alignment provided by the first ML model's transformation), pixel-level discrepancies between the simulated image and the actual runtime image can be identified by comparing the runtime image with the simulated image, which are indicative of defects, contamination, or other anomalies.

This complementary approach, i.e., using design-based shape alignment for high-level pattern defects, and simulated image comparison for more subtle fine-grained anomalies, provides a more comprehensive defect detection strategy. This dual approach addresses different defect scales, resulting in a more robust and sensitive defect detection solution.

In certain embodiments, the defect-detection functionality can be facilitated by training the ML models exclusively on “clean” or nominal images, i.e., images known (or assumed) to be free of defects. By restricting the training set to such clean images, both the first ML model (responsible for geometric transformations) and the second ML model (responsible for image simulation) inherently learn only the normal, expected behaviors of the semiconductor patterns. As a result, during the inference phase, if the runtime image contains defects not represented in the training data, those defects will not be reproduced in the transformed design image or the simulated image generated by the trained models. Instead, the first ML model will simply align the design data with the nominal, expected shape of the runtime image, reflecting the absence of defects, while the second ML model will synthesize an idealized version of the wafer image without including any unmodeled anomalies.

Consequently, the defect-free outputs (i.e., the transformed design image or the simulated image) can be used as references, and discrepancies between the actual, possibly defective runtime image and the defect-free outputs can serve as clear indicators of defects. In addition to improved defect detection performance, this approach can also eliminate the need for explicitly labeling or modeling a wide variety of defect types during training, and leverages the models' inherent bias toward “normal” patterns to detect deviations indicative of defects or anomalies in the runtime phase.

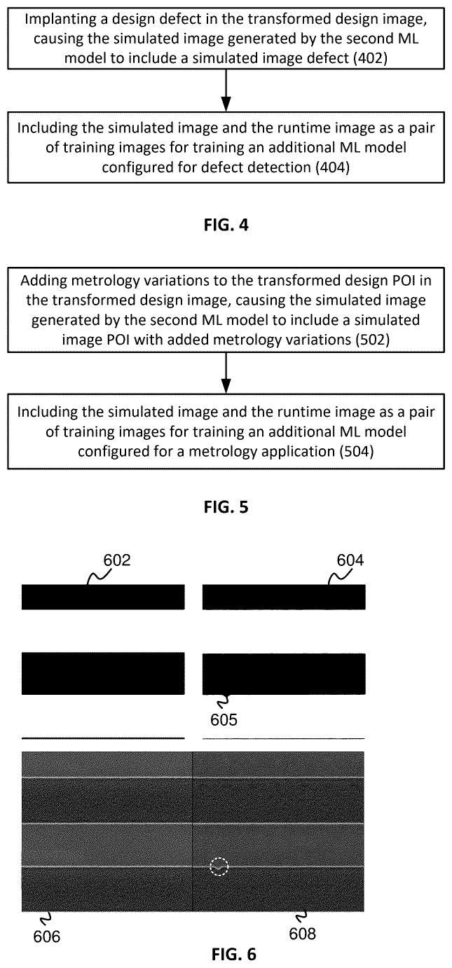

In some embodiments, the outputs of the ML models—specifically, the transformed design image generated by the first ML model and the simulated image generated by the second ML model, can be leveraged to enrich training data for building or improving other ML models, as will be described below with reference to FIGS. 4 and 5. For instance, a newly developed ML model for defect detection may require a broad spectrum of defect examples to achieve robust performance. By selectively implanting synthetic defects into the transformed design image before feeding it to the second ML model, one can systematically generate simulated images that mimic real defects. This approach facilitates the creation of diverse, labeled defect scenarios without the need to find or fabricate actual defects on wafers, thereby reducing cost and time to recipe.

FIG. 4 illustrates a generalized flowchart of such training data enrichment for a ML model dedicated to defect detection, according to certain embodiments of the presently disclosed subject matter.

Continuing with the operational setting as described in FIG. 3, the system obtains a runtime image (one that may or may not contain real-world defects) along with corresponding design data. The previously described first ML model (e.g., an STN or alternative spatial transformation network) aligns the design image to the runtime image, and the second ML model simulates an image from the aligned (transformed) design data. Once these outputs have been generated, further manipulations can be performed to artificially introduce defects at the design level, which then manifest in the simulated image.

Specifically, a design defect can be implanted (402) in the transformed design image, causing the simulated image generated by the second ML model to include a corresponding simulated image defect. By way of example, this process may begin by selecting a target region within the transformed design image (e.g., a particular line, via, or shape boundary) to which an artificial design defect is added. Examples of design defects may include (but are not limited to) shape distortions (e.g., breaks, bridging, extra protrusions), missing features, incorrect pattern spacing, or other anomalies relevant to semiconductor manufacturing. Because the second ML model was trained to translate design-based representations into realistic wafer-like images, these artificially introduced defects will similarly appear in the simulated image, reflecting how such defects might look under a real imaging modality (e.g., SEM). By systematically varying the location, size, and type of the implanted design defect, a wide range of defect-containing images can be generated with minimal manual labor and no need for actual wafer modifications.

Moreover, it is generally simpler to implant or modify defects in a design image, which often has a binary or polygon-based representation, than to manipulate a complex, grayscale (or color) real image. Because design images are composed of well-defined shapes and outlines (e.g., polygons representing features), inserting a new defect or altering an existing shape can be accomplished with straightforward modifications (e.g., adding a break or gap to a line). By contrast, real images can contain varied intensity levels, noise, lighting artifacts, and other complexities that make manual image editing more cumbersome and prone to inaccuracies. Hence, the ability to manipulate design images directly provides a more efficient and controlled method for generating synthetic defect patterns and subsequently simulating their appearance in the final wafer-like images.

The simulated image and the runtime image can be included (404) as a pair of training images for training an additional ML model configured for defect detection. In other words, the runtime image (which may serve as a “clean” reference or simply a real image from production) and the newly generated, defect-laden simulated image, form an instructive data pair for supervised or semi-supervised learning. The resulting training set can be used to improve an existing defect detection algorithm or to develop a new one, enabling that algorithm to recognize a wider spectrum of potential defects. This data enrichment strategy ensures that the defect detection model is exposed to diverse, high-fidelity examples of pattern-related anomalies, yielding stronger generalization and higher detection sensitivity in real-world applications. Furthermore, labeling or annotation for ground truth is simplified, because the exact nature and location of each artificially implanted defect is inherently known, thereby eliminating the typically time-intensive process of manually annotating defects in real wafer images.

FIG. 6 illustrates an example of how training data can be enriched by implanting an artificial defect into the transformed design image and subsequently generating a simulated image that reflects the defect in accordance with certain embodiments of the presently disclosed subject matter. This process enables the creation of labeled training pairs for developing or improving ML models dedicated to defect detection.

In the depicted embodiment, image 602 is the original design image, representing an idealized horizontal line pattern (e.g., from CAD or mask data). Image 604 is the transformed design image, which functions as a segmentation map of the corresponding runtime image 606. In the example shown, image 606 is exemplified as an SEM image that reveals the real appearance of the horizontal line structures on the wafer surface. The transformation is learned and applied by the first ML model, aligning the idealized design data from image 602 to the actual geometry captured in the real wafer's runtime image 606. Once the design has been transformed, the second ML model can generate a simulated SEM image 608 that closely resembles the real SEM image 606.

Notably, FIG. 6 demonstrates how a design defect 605 can be artificially introduced (or “implanted”) into the transformed design image 604. In the example shown, the defect is illustrated as a protrusion on a line structure, although many other defect types can be imagined, such as e.g., breaks, bridges, missing features, or excess deposits. Because the second ML model converts the transformed design image into a realistic simulated image, the implanted defect 605 appears in the simulated image 608 (highlighted by the dashed circle) in a manner consistent with how such a defect might manifest in a real SEM image.

By thus modifying the transformed design image 604 and generating the corresponding simulated image 608, the system produces a controlled, labeled data pair (i.e., 608 vs. 606) for training an additional ML model for defect detection. The original runtime image 606 might be “clean” or otherwise free of that specific defect, whereas the synthetic image 608 now contains the newly introduced anomaly. This contrast allows a supervised learning model to learn to distinguish between nominal (defect-free) and defect-containing conditions. Furthermore, the advantage of implanting defects at the design level lies in the simplicity and control offered by binary or polygon-based design images, enabling the user to systematically generate a wide variety of defect scenarios without the need for actual wafer fabrication or physical defect induction.

FIG. 5 illustrates a generalized flowchart of another training data enrichment process for an ML model dedicated to metrology, according to certain embodiments of the presently disclosed subject matter. Similar to defect detection (as described with reference to FIG. 4), the process here leverages the outputs of the first and second ML models, namely the “transformed design image” (capturing the shape alignment) and the resultant “simulated image”, to generate targeted training data that reflects realistic wafer conditions, including various dimensional variations.

Specifically, metrology variations (e.g., variations in critical dimensions (CD), overlay offsets, or line edge placement) can be added (502) to the transformed design POI in the transformed design image, causing the simulated image generated by the second ML model to include a simulated image POI with added metrology variations.

By way of example, the system can first identify the design structures of interest (e.g., lines, trenches, contact holes) within the transformed design image. Localized modifications are then introduced to enlarge, shrink, shift, or otherwise adjust critical dimensions, e.g., for CD applications. For overlay, the pattern from one layer might be systematically displaced/shifted in the transformed design image relative to another layer or reference mark. Because the second ML model was trained to perform image domain translation while preserving shape details, these “artificial” dimensional changes in the transformed design image will manifest in the simulated image as plausible, photo- or SEM-realistic variations. This allows for a controlled and systematic generation of simulated metrology variations/deviations without requiring real wafer experiments or manual creation of anomalies at the fabrication stage.

Subsequently, the simulated image and the original runtime image (which serves as a baseline or real-world reference) can be included (504) as a pair of training images for training an additional ML model configured for metrology tasks. Such tasks may include CD applications, such as measuring line widths, sidewall angles, and pitch dimensions, overlay applications for obtaining overlay displacements, or other metrology applications that are used for ensuring fabrication integrity and device performance. By exposing the metrology ML model to multiple instances of artificially introduced yet realistically rendered variations, one can build a robust training set that encompasses a broad range of dimensional deviations. This enables improved generalization and accuracy when the ML model is later deployed in real production environments. Furthermore, because the dimensional changes are precisely known (having been deliberately introduced at step 502), the labeling or ground truth for these variations can be automatically assigned to each simulated image, obviating the need for manual measurement or annotation.

Altogether, by manipulating the transformed design image to include controlled dimensional shifts and inconsistencies, and then generating corresponding simulated images via the second ML model, one can iteratively create high-quality, labeled training datasets. These datasets facilitate the development of metrology ML models that can robustly detect and quantify subtle process variations, thus enhancing process control, reducing production costs, and accelerating time-to-recipe for advanced semiconductor devices.

It is to be noted that examples illustrated in the present disclosure, such as, e.g., the exemplified design and image representations, the exemplified ML models, the training sets, and the specific loss functions, etc., are illustrated for exemplary purposes, and should not be regarded as limiting the present disclosure in any way. Other appropriate examples/implementations can be used in addition to, or in lieu of the above.

Overall, certain embodiments of the presently disclosed subject matter achieve a unified machine-learning solution that automates design-based segmentation, realistic image simulation, and data enrichment for semiconductor examination. By integrating a first ML model specialized in spatial transformations (thereby capturing process variation through localized deformations) with a second ML model focused on realistic domain translation, the proposed solution not only obviates the need for manual annotation or rigid alignment but also preserves actual process variations in the simulated images. Consequently, the system provides accurate runtime segmentation, high-fidelity simulated images for enhanced defect detection, and possible data enrichment strategies for various examination applications ranging from defect detection to critical dimension (CD) or overlay metrology.

Specifically, among the advantages of certain embodiments of the presently disclosed subject matter as described herein, is the elimination of ground truth segmentation for training. Specifically, by jointly training the first and second ML models in an end-to-end manner, the system learns to perform spatial transformation and image simulation without relying on pixel-by-pixel annotated segmentation maps. The first ML model automatically transforms the design image to the shape of the actual image, while the second ML model uses the resulting transformed design image for realistic simulation. This synergy ensures accurate segmentation-like outputs (i.e., transformed design images) without the need for time-consuming, error-prone manual labeling.

Among further advantages of certain embodiments of the presently disclosed subject matter as described herein, is the reduced requirement for rigid registration. Traditionally, design data and wafer images must be rigorously aligned at the outset, a step that can be cumbersome and prone to inaccuracies, especially when large-scale variations exist. In contrast, the first ML model's learned local transformations handle the fine-grained matching between design patterns and actual wafer images, thus making rigid, precise alignment optional, or at least far less critical. A simple coarse alignment, if performed at all, suffices to bring the images to roughly the same field of view, with the model taking care of the remaining distortions.

Another technical advantage of certain embodiments of the presently disclosed subject matter is the capability to preserve realistic process variation (PV) in simulated images. By separating the role of shape alignment (handled by the first ML model) from the role of domain translation (handled by the second ML model), the system ensures that any real-world PV contained in the wafer images is learned and replicated, rather than randomly hallucinated. Consequently, when generating simulated images from a transformed design image, the second ML model reproduces the same localized dimensional shifts, line edge roughness, or other subtle variations originally present in the runtime image, providing more accurate references for inspection and metrology.

Among further advantages of certain embodiments of the presently disclosed subject matter as described herein, is the enhancement of training data for defect detection. Because the first ML model outputs a design-based segmentation map that can be easily manipulated, defects can be artificially implanted at the design level, and the second ML model then generates corresponding simulated images containing those artificial defects. Paired with the original runtime image, this yields a labeled set of defective versus non-defective images, significantly enriching the training corpus for any additional ML model focused on defect detection. This approach obviates the need to physically create diverse defect scenarios on wafers, reducing cost, time, and complexity.

Among further advantages of certain embodiments of the presently disclosed subject matter as described herein, is the ability to create synthetic training data for metrology. By introducing controlled metrology variations, such as critical dimension (CD) or overlay offsets, into the transformed design image, the second ML model can generate simulated images that incorporate these variations in a realistic manner. These paired “modified vs. original” images can then be used to train or refine ML models dedicated to metrology tasks, resulting in more robust measurement tools capable of handling a wide array of potential dimensional discrepancies without requiring extensive wafer-based experiments.

It is to be understood that the present disclosure is not limited in its application to the details set forth in the description contained herein or illustrated in the drawings.

In the present detailed description, numerous specific details are set forth in order to provide a thorough understanding of the disclosure. However, it will be understood by those skilled in the art that the presently disclosed subject matter may be practiced without these specific details. In other instances, well-known methods, procedures, components, and circuits have not been described in detail so as not to obscure the presently disclosed subject matter.

Unless specifically stated otherwise, as apparent from the present discussions, it is appreciated that throughout the specification discussions utilizing terms such as “obtaining”, “examining”, “training”, “using”, “processing”, “applying”, “detecting”, “implanting”, “including”, “adding”, “optimizing”, “providing”, “aligning”, or the like, refer to the action(s) and/or process(es) of a computer that manipulate and/or transform data into other data, said data represented as physical, such as electronic, quantities and/or said data representing the physical objects.

The terms “computer”, “computer-based system” or “computerized system” should be expansively construed to cover any kind of hardware-based electronic device with a data processing circuitry (e.g., digital signal processor (DSP), a graphics processing unit (GPU), a field programmable gate array (FPGA), including, by way of non-limiting example, the examination system, the image segmentation and simulation system, the ML system, and respective parts thereof disclosed in the present application. The data processing circuitry (designated also as processing circuitry) can comprise, for example, one or more processors operatively connected to computer memory, loaded with executable instructions for executing operations. The data processing circuitry encompasses a single processor or multiple processors, which may be located in the same geographical zone, or may, at least partially, be located in different zones, and may be able to communicate together.

The one or more processors referred to herein can represent one or more general-purpose processing devices such as a microprocessor, a central processing unit, or the like. More particularly, a given processor may be one of a complex instruction set computing (CISC) microprocessor, a reduced instruction set computing (RISC) microprocessor, a very long instruction word (VLIW) microprocessor, a processor implementing other instruction sets, or a processor implementing a combination of instruction sets. The one or more processors may also be one or more special-purpose processing devices such as an application-specific integrated circuit (ASIC), a field programmable gate array (FPGA), a digital signal processor (DSP), a network processor, or the like. The one or more processors are configured to execute instructions for performing the operations and steps discussed herein.

The memories referred to herein can comprise one or more of the following: internal memory, such as, e.g., processor registers and cache, etc., main memory such as, e.g., read-only memory (ROM), flash memory, dynamic random access memory (DRAM) such as synchronous DRAM (SDRAM) or Rambus DRAM (RDRAM), etc.

The terms “non-transitory memory” and “non-transitory storage medium” used herein should be expansively construed to cover any volatile or non-volatile computer memory suitable to the presently disclosed subject matter. The terms should be taken to include a single medium or multiple media (e.g., a centralized or distributed database, and/or associated caches and servers) that store the one or more sets of instructions. The terms shall also be taken to include any medium that is capable of storing or encoding a set of instructions for execution by the computer and that cause the computer to perform any one or more of the methodologies of the present disclosure. The terms shall accordingly be taken to include, but not be limited to, a read only memory (“ROM”), random access memory (“RAM”), magnetic disk storage media, optical storage media, flash memory devices, etc.

The term “specimen” used in this specification should be expansively construed to cover any kind of physical objects or substrates including wafers, masks, reticles, and other structures, combinations and/or parts thereof used for manufacturing semiconductor integrated circuits, magnetic heads, flat panel displays, and other semiconductor-fabricated articles. A specimen is also referred to herein as a semiconductor specimen, and can be produced by manufacturing equipment executing corresponding manufacturing processes.

The term “examination” used in this specification should be expansively construed to cover any kind of operations related to defect detection, defect review, and/or defect classification of various types, segmentation, and/or metrology operations during and/or after the specimen fabrication process. Examination is provided by using non-destructive examination tools during or after manufacture of the specimen to be examined. By way of non-limiting example, the examination process can include runtime scanning (in a single or in multiple scans), imaging, sampling, detecting, reviewing, measuring, classifying, and/or other operations provided with regard to the specimen or parts thereof, using the same or different inspection tools. Likewise, examination can be provided prior to manufacture of the specimen to be examined, and can include, for example, generating an examination recipe(s) and/or other setup operations. It is noted that, unless specifically stated otherwise, the term “examination”, or its derivatives used in this specification, is not limited with respect to resolution or size of an inspection area. A variety of non-destructive examination tools includes, by way of non-limiting example, scanning electron microscopes (SEM), atomic force microscopes (AFM), optical inspection tools, etc.

The term “metrology operation” used in this specification should be expansively construed to cover any metrology operation procedure used to extract metrology information relating to one or more structural elements on a semiconductor specimen. In some embodiments, the metrology operations can include measurement operations, such as, e.g., critical dimension (CD) measurements performed with respect to certain structural elements on the specimen, including but not limited to the following: dimensions (e.g., line widths, line spacing, contact diameters, size of the element, edge roughness, gray level statistics, etc.), shapes of elements, distances within or between elements, related angles, overlay information associated with elements corresponding to different design levels, etc. Measurement results such as measured images are analyzed, for example, by employing image-processing techniques. Note that, unless specifically stated otherwise, the term “metrology”, or derivatives thereof used in this specification, is not limited with respect to measurement technology, measurement resolution, or size of inspection area.

The term “defect” used in this specification should be expansively construed to cover any kind of abnormality or undesirable feature/functionality formed on a specimen. In some cases, a defect may be a defect of interest (DOI) which is a real defect that has certain effects on the functionality of the fabricated device, thus is in the customer's interest to be detected. For instance, any “killer” defects that may cause yield loss can be indicated as a DOI. In some other cases, a defect may be a nuisance (also referred to as a “false alarm” defect) which can be disregarded because it has no effect on the functionality of the completed device and does not impact yield.

The term “defect candidate” used in this specification should be expansively construed to cover a suspected defect location on the specimen which is detected to have a relatively high probability of being a defect of interest (DOI). Therefore, a DOI candidate, upon being reviewed/tested, may actually be a DOI, or, in some other cases, it may be nuisances, or random noise that can be caused by different variations (e.g., process variation, color variation, mechanical and electrical variations, etc.) during inspection.

The term “design data” used in the specification should be expansively construed to cover any data indicative of hierarchical physical design (layout) of a specimen. Design data can be provided by a respective designer and/or can be derived from the physical design (e.g., through complex simulation, simple geometric and Boolean operations, etc.). Design data can be provided in different formats as, by way of non-limiting examples, GDSII format, OASIS format, etc. Design data can be presented in vector format, grayscale intensity image format, or otherwise.

The term “image(s)” or “image data” used in the specification should be expansively construed to cover any original images/frames of the specimen captured by an examination tool during the fabrication process, derivatives of the captured images/frames obtained by various pre-processing stages, and/or computer-generated synthetic images (in some cases based on design data). Depending on the specific way of scanning (e.g., one-dimensional scan such as line scanning, two-dimensional scan in both x and y directions, or dot scanning at specific spots, etc.), image data can be represented in different formats, such as, e.g., as a gray level profile, a two-dimensional image, or discrete pixels, etc. It is to be noted that in some cases the image data referred to herein can include, in addition to images (e.g., captured images, processed images, etc.), numeric data associated with the images (e.g., metadata, hand-crafted attributes, etc.). It is further noted that images or image data can include data related to a processing step/layer of interest, or a plurality of processing steps/layers of a specimen.

It is appreciated that, unless specifically stated otherwise, certain features of the presently disclosed subject matter, which are described in the context of separate embodiments, can also be provided in combination in a single embodiment. Conversely, various features of the presently disclosed subject matter, which are described in the context of a single embodiment, can also be provided separately or in any suitable sub-combination. In the present detailed description, numerous specific details are set forth in order to provide a thorough understanding of the methods and apparatus.

It will also be understood that the system according to the present disclosure may be, at least partly, implemented on a suitably programmed computer. Likewise, the present disclosure contemplates a computer program being readable by a computer for executing the method of the present disclosure. The present disclosure further contemplates a non-transitory computer-readable memory tangibly embodying a program of instructions executable by the computer for executing the method of the present disclosure.

The present disclosure is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

Those skilled in the art will readily appreciate that various modifications and changes can be applied to the embodiments of the present disclosure as hereinbefore described without departing from its scope, defined in and by the appended claims.

1. A computerized system for examining a semiconductor specimen, the system comprising a processing circuitry configured to:
obtain a runtime image capturing an image pattern of interest (POI) in the specimen, and a design image containing a design POI corresponding to the image POI;
use a trained first machine learning (ML) model to process the runtime image and the design image, to obtain a spatial transformation map indicative of spatial transformation from the design POI to the image POI; and
apply the spatial transformation map on the design image to obtain a transformed design image comprising a transformed design POI matching geometry of the image POI in the runtime image;
wherein the first ML model has been previously trained as part of an ML system in conjunction with a second ML model, the first ML model being trained for spatial transformation from design patterns to corresponding image patterns, while the second ML model being trained for image simulation based on output of the first ML model.

2. The computerized system according to claim 1, wherein the processing circuitry is further configured to use the transformed design image to obtain a metrology measurement for the runtime image.

3. The computerized system according to claim 1, wherein the processing circuitry is further configured to detect a first type of defects with respect to the image POI based on the transformed design image and the design image.

4. The computerized system according to claim 1, wherein the processing circuitry is further configured to use the trained second ML model to process the transformed design image to generate a simulated image thereof.

5. The computerized system according to claim 4, wherein the processing circuitry is further configured to detect a second type of defects on the specimen based on the simulated image and the runtime image.

6. The computerized system according to claim 4, wherein the processing circuitry is further configured to:
implant a design defect in the transformed design image, causing the simulated image generated by the second ML model to include a simulated image defect; and
include the simulated image and the runtime image as a pair of training images for training an additional ML model configured for defect detection.

7. The computerized system according to claim 4, wherein the processing circuitry is further configured to:
add metrology variations to the transformed design POI in the transformed design image, causing the simulated image generated by the second ML model to include a simulated image POI with added metrology variations; and
include the simulated image and the runtime image as a pair of training images for training an additional ML model configured for a metrology application.

8. The computerized system according to claim 1, wherein the runtime image and the design image are coarsely aligned, without rigid registration.

9. The computerized system according to claim 1, wherein the first ML model and the second ML model have been trained in conjunction using one or more loss functions comprising a first loss function configured for preserving continuity in the output of the first ML model.

10. The computerized system according to claim 9, wherein the one or more loss functions further comprise a second loss function configured to reduce a difference between output of the second ML model and a corresponding actual image.

11. A computerized method of training a machine learning (ML) system comprising a first ML model and a second ML model, the method comprising:
obtaining a training set comprising one or more image pairs, each image pair comprising an actual image capturing an image training pattern and a design image containing a design training pattern corresponding to the image training pattern;
for each image pair in the training set, processing the image pair using the first ML model to obtain a spatial transformation map indicative of spatial transformation from the design training pattern to the image training pattern;
applying the spatial transformation map on the design image to obtain a transformed design image comprising a transformed design training pattern matching geometry of the image training pattern in the actual image;
processing the transformed design image using the second ML model to obtain a simulated image; and
optimizing the first ML model and the second ML model together using one or more loss functions based on the spatial transformation map, the simulated image, and the actual image.

12. The computerized method according to claim 11, wherein the first ML model, upon being trained, is usable for providing a segmentation map for a runtime image based on a corresponding design image thereof.

13. The computerized method according to claim 11, wherein the second ML model, upon being trained, is usable for providing a simulated image based on a design image or a transformed design image of a runtime image.

14. The computerized method according to claim 13, wherein the simulated image has preserved process variation with respect to the runtime image.

15. The computerized method according to claim 11, wherein the one or more loss functions comprise a first loss function to be applied on the spatial transformation map, the first loss function configured for preserving continuity of the transformed design training pattern in the transformed design image.

16. The computerized method according to claim 15, wherein the one or more loss functions further comprise a second loss function configured to reduce a difference between the simulated image and the actual image.

17. The computerized method according to claim 11, wherein the actual image and the design image in an image pair are coarsely aligned, without rigid registration.

18. The computerized method according to claim 11, wherein the actual image in each image pair of the training set is a nominal image free of defects.

19. The computerized method according to claim 11, wherein the first ML model is trained without a ground truth segmentation map.

20. A non-transitory computer readable storage medium tangibly embodying a program of instructions that, when executed by a computer, cause the computer to perform a method of examining a semiconductor specimen, the method comprising:
obtaining a runtime image capturing an image pattern of interest (POI) in the specimen, and a design image containing a design POI corresponding to the image POI;
using a trained first machine learning (ML) model to process the runtime image and the design image, to obtain a spatial transformation map indicative of spatial transformation from the design POI to the image POI; and
applying the spatial transformation map on the design image to obtain a transformed design image comprising a transformed design POI matching geometry of the image POI in the runtime image;
wherein the first ML model has been previously trained as part of an ML system in conjunction with a second ML model, the first ML model being trained for spatial transformation from design patterns to corresponding image patterns, while the second ML model being trained for image simulation based on output of the first ML model.
